(19) United States
(12) Patent Application Publication
(10) Pub. No.: US 2010/0242929 A1
(43) Pub. Date: Sep. 30, 2010

(54) ARRANGEMENT AND METHOD FOR THE RETURN OF EXHAUST GASES IN A COMBUSTION ENGINE

(76) Inventors: Zoltan Kardos, Sodertalje (SE); Erik Söderberg, Stockholm (SE)

Correspondence Address: OSTROLENK FABER GERB & SOFFEN, 1180 AVENUE OF THE AMERICAS, NEW YORK, NY, 100368403, US

(21) Appl. No.: 12/743,860

(22) PCT Filed: Nov. 18, 2008
(86) PCT No.: PCT/SE08/51323

§ 371 Date: Jun. 1, 2010

(30) Foreign Application Priority Data
Dec. 7, 2007 (SE) 0702729-5

(51) Int. Cl. F02M 25/07

(52) U.S. Cl. 123/568.12

(57) ABSTRACT

An arrangement and a method for recirculation of exhaust gases of a combustion engine. A return line returns exhaust gases to the combustion engine. An EGR cooler device cools the exhaust gases before the gases are led to the combustion engine. A container gathers condensate which forms in the EGR cooler device. A line connects the container to a flow section for the exhaust gases in the EGR cooler device. A driver leads condensate from the container into the flow section for the exhaust gases in the EGR cooler device.

### CROSS REFERENCE TO RELATED APPLICATION

The present application is a 35 U.S.C. §§371 national phase conversion of PCT/SE2008/051323, filed Nov. 18, 2008, which claims priority of Swedish Application No. 0702729-5, filed Dec. 7, 2007, the disclosure of which is incorporated by reference herein. The PCT International Application was published in the English language.

### BACKGROUND TO THE INVENTION, AND STATE OF THE ART

The present invention relates to an arrangement and a method for recirculation of exhaust gases of a combustion engine wherein condensate formed at an EGR cooler in the exhaust gas return line is gathered and removed, and also aids in cleaning the return line.

The technique called EGR (Exhaust Gas Recirculation) is a known way of leading part of the exhaust gases from a combustion process in a combustion engine back, via a return line, to a line for supply of air to the combustion engine. A mixture of air and exhaust gases is supplied via the air line to the engine's cylinders in which the combustion takes place. Adding exhaust gases to the air causes a lower combustion temperature resulting inter alia in the exhaust gases having a reduced content of nitrogen oxides NOₓ. This technique is used both for Otto engines and for diesel engines.

The return line for the exhaust gases comprises inter alia an EGR valve which is settable so that a desired amount of exhaust gases is recirculated. An electrical control unit is configured to control the EGR valve on the basis inter alia of information about the load of the combustion engine. The return line also comprises at least one EGR cooler operable to cooling the exhaust gases in the return line before they are mixed with the air and led to the engine. In course of time, soot deposits from the exhaust gases inevitably form on the inside surfaces of the EGR cooler, thereby impairing the heat transfer capacity of the EGR cooler and at the same time increasing the resistance to the flow of exhaust gases through the EGR cooler. The presence of the soot deposits reduces the performance of the combustion engine and increases the content of nitrogen oxides in the exhaust gases.

U.S. Pat. No. 6,904,898 discloses an arrangement for recirculation of exhaust gases of a supercharged combustion engine in which the recirculating exhaust gases are cooled in an EGR cooler by means of a coolant. If the coolant is at a temperature below a threshold value, there is risk of the exhaust gases being cooled to a temperature such that condensate forms within the EGR cooler. During normal operation, to prevent the formation of condensate, no recirculation of exhaust gases through the EGR cooler is allowed when the coolant is at a temperature below said threshold value. In circumstances where the EGR cooler needs cleaning from soot deposits, however, exhaust gases are allowed to recirculate through the EGR cooler when the coolant is at a temperature below said threshold value. In such cases, condensate forms on the internal surfaces of the EGR cooler and effectively dissolves any soot deposits on them. However, the recirculating exhaust gases will be at above the condensation temperature during their main passage through the EGR cooler. Substantially the only results will be the formation of condensate within a final portion of the EGR cooler and the cleaning of the internal surfaces in this final portion of the EGR cooler which follows.

### SUMMARY OF THE INVENTION

The object of the present invention is to provide an arrangement and a method whereby the internal surfaces of an EGR cooler device are kept clean of soot deposits from the exhaust gases in a simple and effective manner.

This object is achieved with the arrangement of the invention. Exhaust gases recirculated in a combustion engine are cooled in an EGR cooler device which may comprise one or more EGR coolers before the gases are mixed with compressed air and led to combustion engine. If the exhaust gases are cooled effectively, they reach at a location within the EGR cooler device a temperature at which the water vapor in the exhaust gases condenses. Condensate will therefore form from that location in the EGR cooler device to an aperture through which the exhaust gases are led out from the EGR cooler device. The exhaust gases from a combustion engine usually contain a small amount of sulphur. Consequently, the water vapor which condenses in an EGR cooler device forms a condensate which has a low pH value. This condensate is very suitable for use as a cleaning agent for removing soot deposits in an EGR cooler device. The furthest downstream portions of an EGR cooler device in which condensate normally forms during operation of a combustion engine is therefore usually substantially freed of soot deposits. According to the invention, the condensate formed is also used for cleaning other portions of the EGR cooler device. Condensate is thus accumulated in a container device before it is led through a line to a suitable portion of the EGR cooler device where it is led in and mixed with the flowing exhaust gases. The condensate led into the EGR cooler device effectively dissolves the soot deposits on the internal surfaces of the EGR cooler device. The soot deposits released from the walls are carried off out of the EGR cooler device by the exhaust flow. However, the warm exhaust gases relatively quickly vaporise the condensate. This vaporisation results in the exhaust gases undergoing extra cooling in the EGR cooler device. The exhaust gases are thus cooled more quickly in the EGR cooler device in situations where condensate is supplied. The water vapor in the exhaust gases therefore reaches its condensation temperature relatively quickly and condensate forms at a location further upstream in the EGR cooler device. Supplying a suitable amount of condensate will make it possible for substantially all of the internal surfaces of the EGR cooler device which are situated downstream of the location where condensate is added to be coated with condensate and cleaned of soot deposits.

According to a preferred embodiment of the present invention, said flow section for the exhaust gases where condensate is led into the EGR cooler device is situated close to an inlet section for the exhaust gases in the EGR cooler device. This means that substantially all of the internal surfaces of the EGR cooler device can at least for a short time be coated with condensate and cleaned of soot deposits. Said container device is with advantage situated close to an outlet section for the exhaust gases in the EGR cooler device. Condensate forms most abundantly at the end of the EGR cooler device and can be gathered substantially directly in a container device which is so positioned. Condensate which forms earlier in the EGR cooler device is carried by the exhaust flow to the outlet section and accumulates there. In cases where the EGR cooler device comprises an air-cooled EGR cooler with a conventional configuration, the condensate may thus accumulate on a bottom portion of an outlet tank of the EGR cooler.

According to another preferred embodiment of the present invention, said driving means comprises a pump adapted to being activated when condensate is to be supplied to the EGR cooler device. With a pump arranged at a suitable location in the line, condensate can be supplied to the EGR cooler device on desired occasions and in a desired amount. Condensate may be supplied substantially continuously during operation of the combustion engine or at specified intervals. Alternatively, the pressure drop or cooling of the exhaust gases passing through the EGR cooler device may be detected. A large pressure drop or little cooling of the exhaust gases passing through the EGR cooler device will indicate that it may need cleaning. Alternatively, said driving means may involve said flow section for the exhaust gases in the EGR cooler device where condensate is led into the EGR cooler device being so configured that it narrows locally relative to adjacent flow sections. The exhaust gases which flow through the narrowing flow section will thus assume a greater velocity, thereby reducing the stationary pressure in that section. Condensate can thereby be drawn from the gathering container, through a line and into said section. The line comprises with advantage a valve by which the flow of condensate to the EGR cooler device is regulated. Condensate can therefore be supplied on desired occasions and in desired amounts. The arrangement comprises preferably a control unit adapted to controlling said driving means so that condensate is supplied on desired occasions and in a desired amount. Such a control unit, which may be a computer unit with suitable software, makes it possible for the EGR cooler device to be cleaned with condensate in such a way that the whole EGR cooler device's internal surfaces which are in contact with the exhaust gases are kept substantially free from soot deposits. The capacity of the EGR cooler device is thus maintained substantially unchanged during operation of combustion engine.

According to a preferred embodiment of the present invention, the EGR cooler device comprises a first EGR cooler adapted to subjecting the exhaust gases to a first step of cooling, and a second EGR cooler adapted to subjecting the exhaust gases to a second step of cooling. Cooling the exhaust gases from a temperature of about 500-600° C. to a temperature close to that of the surroundings is facilitated if the exhaust gases are cooled in a number of stages. To this end, the exhaust gases may undergo cooling by a coolant in the first EGR cooler. The coolant may take the form of the coolant of combustion engine's cooling system. That coolant will certainly be at a relatively high temperature but nevertheless at a definitely lower temperature than the exhaust gases led into the first EGR cooler. The exhaust gases may undergo cooling by air at the temperature of the surroundings in the second EGR cooler. The exhaust gases may thus be subjected to a second step of cooling to a temperature close to that of the surroundings, and to a temperature corresponding to that to which the compressed air is cooled in a charge air cooler.

The object indicated above is also achieved with the method of the invention which uses the above described arrangement.

### BRIEF DESCRIPTION OF THE DRAWINGS

Preferred embodiments of the present invention are described below by way of examples with reference to the attached drawings, in which:

FIG. 1 depicts an arrangement with a return line for recirculation of exhaust gases of a supercharged combustion engine,

FIG. 2 depicts a first embodiment of an arrangement for cleaning an EGR cooler in the return line,

FIG. 3 depicts a second embodiment of an arrangement for cleaning an EGR cooler in the return line and

FIG. 4 depicts a cross-sectional view of the region A in FIG. 3.

### DETAILED DESCRIPTION OF PREFERRED EMBODIMENTS OF THE INVENTION

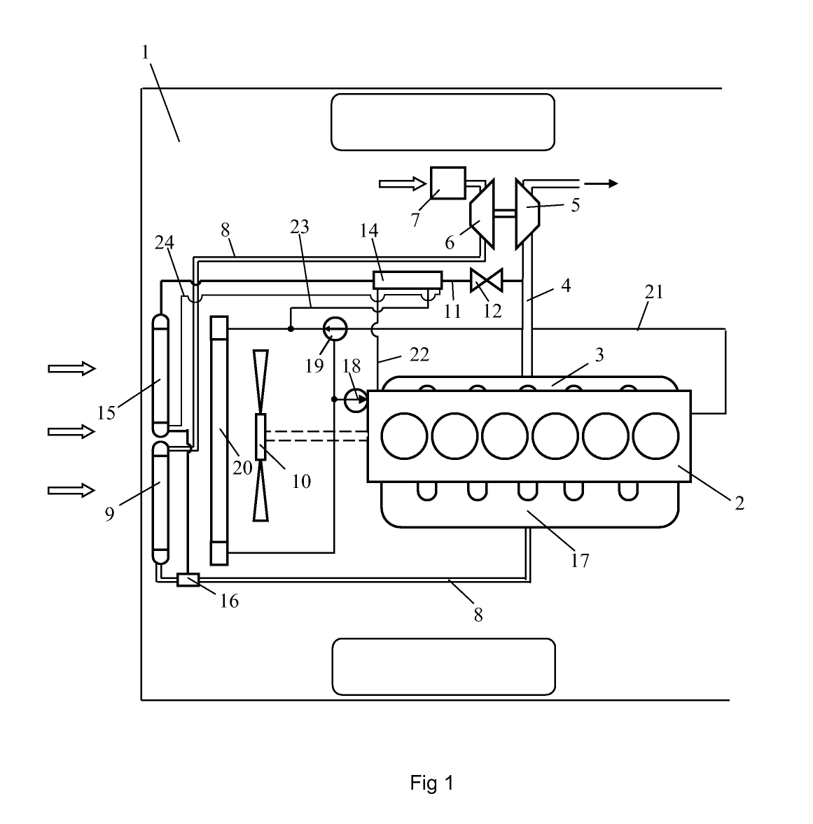

FIG. 1 depicts a vehicle 1 powered by a supercharged combustion engine 2. The vehicle 1 may be a heavy vehicle powered by a supercharged diesel engine. The exhaust gases from the cylinders of the combustion engine 2 are led via an exhaust manifold 3 to an exhaust line 4. The exhaust gases in the exhaust line 4, which will be at above atmospheric pressure, are led to a turbine 5 of a turbo unit. The turbine 5 is thus provided with driving power which is transmitted, via a connection, to a compressor 6. The compressor 6 compresses air which is led via an air filter 7 into an air line 8. A charge air cooler 9 is arranged in the air line 8. The charge air cooler 9 is arranged at a front portion of the vehicle 1. The purpose of the charge air cooler 9 is to cool the compressed air before it is led to the combustion engine 2. The compressed air is cooled in the charge air cooler 9 by surrounding air being caused to flow through the charge air cooler 9 by a radiator fan 10. The radiator fan 10 is driven by the combustion engine 2 via a suitable connection.

The combustion engine 2 is provided with an EGR (Exhaust Gas Recirculation) system for recirculation of the exhaust gases. Adding exhaust gases to the compressed air led to the engine's cylinders lowers the combustion temperature and hence also the content of nitrogen oxides NOₓ formed during the combustion processes. A return line 11 for recirculation of exhaust gases extends from the exhaust line 4 to the air line 8. The return line 11 comprises an EGR valve 12 by which the exhaust flow in the return line 11 can be shut off. The EGR valve 12 may also be used for steplessly controlling the amount of exhaust gases led from the exhaust line 4 to the air line 8 via the return line 11. The return line 11 comprises a first EGR cooler 14 and a second EGR cooler 15 for providing the recirculating exhaust gases with two steps of cooling. In supercharged diesel engines 2, in certain operating situations, the pressure of the exhaust gases in the exhaust line 4 will be lower than the pressure of the compressed air in the inlet line 8. In such operating situations it is not possible to mix the exhaust gases in the return line 11 directly with the compressed air in the inlet line 8 without special auxiliary means. To this end it is possible to use, for example, a venturi 16 or a turbo unit with variable geometry. If instead the combustion engine 2 is a supercharged Otto engine, the exhaust gases in the return line 11 can be led directly into the inlet line 8, since the exhaust gases in the exhaust line 4 of an Otto engine in substantially all operating situations will be at a higher pressure than the compressed air in the inlet line 8. When the exhaust gases have mixed with the compressed air in the inlet line 8, the mixture is led via a manifold 17 to the respective cylinders of the combustion engine 2.

The combustion engine 2 is cooled in a conventional manner by a cooling system which contains a circulating coolant. A coolant pump 18 circulates the coolant in the cooling system. The coolant pump 18 circulates a substantial flow of the coolant through the combustion engine 2. When the coolant has cooled the combustion engine 2, it is led in a line 21 to a thermostat 19 of the cooling system. When the coolant has reached a normal operating temperature, the thermostat 19 is adapted to leading the coolant to a radiator 20 in order to be cooled. Part of the coolant in the cooling system is led, however, via a line 22 to the first EGR cooler 14, in which it subjects the recirculating exhaust gases to a first step of cooling. When the coolant has cooled the exhaust gases in the first EGR cooler 14, it is led back to the line 21 via a line 23. The warm coolant is cooled in the radiator 20, which is fitted at a forward portion of the vehicle 1. The radiator 20 is here nevertheless fitted downstream of the charge air cooler 9 and the air-cooled second EGR cooler 15 with respect to the intended direction of air flow. With such positioning of the second EGR cooler 15 and the charge air cooler 9, the compressed air and the recirculating exhaust gases can be cooled to a temperature close to that of the surroundings. The air and the exhaust gases are cooled so that they occupy a smaller specific volume, thereby making it possible to supply a larger amount of air and recirculating exhaust gases to the cylinders of the combustion engine.

In the course of time, soot deposits inevitably form on the internal surfaces of the EGR coolers 14, 15 which are in contact with the exhaust gases. The heat transfer capacity of the EGR coolers 14, 15 is thus impaired, while at the same time the resistance to the flow of exhaust gases through the EGR coolers 14, 15 increases. The presence of the soot deposits reduces the performance of the combustion engine and increases the content of nitrogen oxides in the exhaust gases. When the exhaust gases are cooled in the second EGR cooler 15, they are usually cooled to a temperature which is lower than condensation temperature of water vapor at the prevailing pressure. Condensate therefore precipitates in the second EGR cooler 15. The fact that the fuel and the exhaust gases contain a small amount of sulphur results in a condensate with a low pH value. The condensate is therefore very suitable for use as a cleaning agent for removing soot deposits. The condensate which precipitates in the second EGR cooler 15 thus keeps substantially the downstream portion of this EGR cooler 15 free from soot deposits.

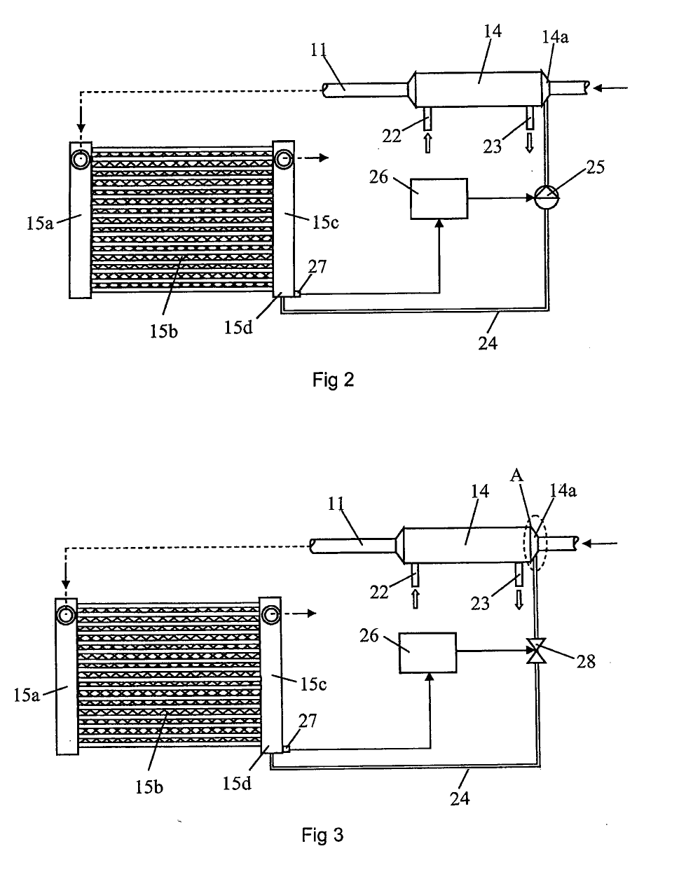

FIG. 2 depicts an embodiment of an arrangement which makes it possible to clean both the first EGR cooler 14 and the second EGR cooler 15 from soot deposits. The second EGR cooler 15 comprises an inlet tank 15a for receiving exhaust gases in the return line 11 which have undergone a first step of cooling in the first EGR cooler 14. The second EGR cooler 15 comprises a radiator portion 15b in which the exhaust gases are subjected to cooling by surrounding air which flows through the cooling portion 15b. The second EGR cooler 15 comprises also an outlet tank 15c for receiving the cooled exhaust gases. In the second EGR cooler 15, the exhaust gases are usually cooled to a temperature such that condensate precipitates within the EGR cooler 15. The condensate accumulates in a bottom portion 15d of the outlet tank 15c. The arrangement comprises a line 24 which connects the bottom portion 15d of the outlet tank 15c to an inlet section 14a of the first EGR cooler 14. The first EGR cooler 14 here takes the form of a counterflow heat exchanger in which the exhaust gases are cooled by the coolant from the combustion engine's cooling system, which is led into the first EGR cooler 14 via the line 22 and out from the first EGR cooler 14 via the line 23. The line 24 comprises a pump 25 for transferring condensate from the bottom portion 15d of the outlet tank to the inlet section 14a of the first EGR cooler 14. A control unit 26 is adapted to controlling the pump 25 on the basis inter alia of information from a sensor 27 which detects the level of the condensate in the bottom portion 15d of the outlet tank 15c.

During operation of the combustion engine 2, when the EGR valve 12 is open, warm exhaust gases are returned through the return line 11. The exhaust gases may be at a temperature of 500-600° C. when they reach the first EGR cooler 14. The exhaust gases are subjected to a first step of cooling in the first EGR cooler 14 by the coolant. When the exhaust gases have been cooled in the first EGR cooler 14, they are led on in the return line 11 to the second EGR cooler 15, in which they are subjected to a second step of cooling by air at the temperature of the surroundings. At a location within the cooling portion 15b of the second EGR cooler, the exhaust gases reach a temperature at which the water vapor in the exhaust gases begins to condense on the internal surfaces of the second EGR cooler 15. The precipitated condensate dissolves any soot deposits within the cooling portion 15b from said location to the outlet tank 15c. A relatively abundant amount of condensate usually forms in the downstream portion of the radiator portion 15b during operation of the combustion engine 2. The condensate formed accumulates in the bottom portion 15d of the outlet tank 15c.

At suitable intervals, the control unit 26 activates the pump 25 so that condensate is pumped through the line 24 from the bottom portion 15d of the outlet tank to the inlet section 14a of the first EGR cooler. If the sensor 27 indicates that there is insufficient condensate in the bottom portion 15d of the outlet tank, the control unit 26 effects activation of the pump 25. The condensate which is led into the first EGR cooler 14 dissolves soot deposits on the internal surfaces of the first EGR cooler 14. The soot deposits are released from the walls and carried off out of the first EGR cooler 14 by the exhaust flow. However, the warm exhaust gases relatively quickly vaporize the condensate. This vaporisation results in the exhaust gases undergoing extra cooling in the first EGR cooler 14. The exhaust gases led to the second EGR cooler 15 thus assume a lower temperature than normal during situations where condensate is led into the first EGR cooler 14. Consequently, the water vapor in the second EGR cooler 15 reaches its condensation temperature significantly more quickly and condensate forms earlier within the radiator portion 15b. Supplying a suitable amount of condensate to the inlet section 14a of the first EGR cooler makes it possible for substantially all the internal surfaces of the two EGR coolers 14, 15 to be coated with condensate and cleaned of soot deposits.

FIGS. 3 and 4 depict an alternative embodiment of the arrangement. In this case the line 24 is provided with a valve 28 which is controlled by a control unit 26. The control unit 26 may here again receive information from a sensor 27 concerning the level of the condensate in the bottom portion 15d of the outlet tank 15c. FIG. 4 depicts a sectional view of the inlet section 14a of the first EGR cooler 14. It shows the inlet section 14a provided with wall portions which define a locally narrowing flow section 29 for the exhaust gases. The line 24 has an orifice in this narrowing flow section 29. The exhaust gases which flow through the return line assume a greater flow velocity in the narrowing flow section 29. The stationary pressure therefore drops in the narrowing flow section 29. The result is a lower pressure in the narrowing flow section 29 than the pressure prevailing in the bottom portion 15d of the outlet tank 15c. During situations where the control unit 26 opens the valve 28, condensate is drawn from the bottom portion 15d of the outlet tank to the inlet section 14a of the first EGR cooler 14. The control unit 26 may keep the valve 28 open for a specified time such that a suitable amount of condensate is supplied to the EGR coolers 14, 15 so that they are cleaned of soot deposits.

The invention is in no way limited to the embodiments illustrated in the drawings but may be varied freely within the scopes of the claims. In the embodiment examples, two EGR coolers are used. The invention is nevertheless applicable to EGR cooler devices which comprise one or more than two EGR coolers. Condensate need not be supplied at an inlet for the exhaust gases in an EGR cooler but may be supplied at other locations in the EGR cooler. Condensate may also be supplied at a number of different locations in one or more EGR coolers.

1. An arrangement for recirculation of exhaust gases of a combustion engine, the arrangement comprising:
a return line for returning exhaust gases to the combustion engine, an EGR cooler device in the return line, the EGR cooler device being located, configured and operative to cool the exhaust gases before they are led by the return line to the combustion engine;
a container connected with the EGR cooler device for gathering condensate which forms in the EGR cooler device during operation thereof, a flow section for the exhaust gases in the EGR cooler device, a connecting line which connects the container to the flow section; and
a driving device configured to lead condensate from the container and into the flow section for the exhaust gases in the EGR cooler device.

2. An arrangement according to claim 1, further comprising an inlet section for exhaust gases in the EGR cooler device; the flow section for the exhaust gases where condensate is led into the EGR cooler device is situated close to the inlet section for the exhaust gases in the EGR cooler device.

3. An arrangement according to claim 2, further comprising an outlet section for exhaust gases from the EGR cooler device; the container is situated close to the outlet section for the exhaust gases from the EGR cooler device.

4. An arrangement according to claim 1, wherein the driving device comprises a pump configured to be activated to pump condensate when condensate is to be supplied to the EGR cooler device.

5. An arrangement according to claim 1, wherein the driving device includes the flow section for the exhaust gases in the EGR cooler device being at a location where condensate is led into the EGR cooler device, and at the location, the flow section for the exhaust gases being configured to have a locally narrowing shape relative to adjacent flow sections for the exhaust gases.

6. An arrangement according to claim 5, wherein the connecting line comprises a valve by which the flow of condensate to the EGR cooler device can be regulated.

7. An arrangement according to claim 1, further comprising a control unit configured to control the driving device so that condensate is led into the flow section on desired occasions and in a desired amount.

8. An arrangement according to claim 1, wherein the EGR cooler device comprises a first EGR cooler located and configured in the return line to subject the exhaust gases to a first step of cooling, and a following second EGR cooler located and configured after the first EGR cooler in the return line to subject the exhaust gases to a second step of cooling.

9. An arrangement according to claim 8, further comprising the first EGR cooler being configured to subject the exhaust gases in the first EGR cooler to cooling by a coolant.

10. An arrangement according to claim 9, further comprising the second EGR cooler being configured to subject the exhaust gases in the second EGR cooler to cooling by air at a temperature of the surroundings.

11. A method for recirculation of exhaust gases of a combustion engine, wherein the combustion engine comprises a return line configured for returning exhaust gases to the combustion engine, and an EGR cooler device in the return line in which the exhaust gases are intended to be cooled,
the method comprising the steps of: passing heated exhaust gases from the engine through the return line, cooling the gases in the EGR cooler device such that condensate is formed in the return line, gathering in a container the condensate which forms in the EGR cooler device and transferring condensate from the container device into a flow section for the exhaust gases in the EGR cooler device.

12. An arrangement as claimed in claim 1, further comprising an outlet section for exhaust gases from the EGR cooler device; and the container is situated close to the outlet section for the exhaust gases from the EGR cooler device.

13. An arrangement as claimed in claim 8, further comprising the second EGR cooler being configured to subject the exhaust gases in the second EGR cooler to cooling by air at a temperature of the surroundings.
